(19) United States
(12) Patent Application Publication
(10) Pub. No.: US 2022/0140663 A1
(43) Pub. Date: May 5, 2022

(54) APPARATUS FOR CHARGING AREA DETECTION

(71) Applicant: NINGBO WEIE ELECTRONICS TECHNOLOGY LTD., Ningbo (CN)

(72) Inventors: Feng Yu, Ningbo (CN); Weiyi Feng, Ningbo (CN); Lizhi Xu, Ningbo (CN)

(73) Assignee: NINGBO WEIE ELECTRONICS TECHNOLOGY LTD., Ningbo (CN)

(21) Appl. No.: 17/507,358

(22) Filed: Oct. 21, 2021

(30) Foreign Application Priority Data
Oct. 29, 2020 (CN) 202011187041.8

(51) Int. Cl. H02J 50/90; H02J 50/12

(52) U.S. Cl. CPC H02J 50/90; H02J 50/12

(57) ABSTRACT

An apparatus for charging area detection is disclosed, and relates to the technical field of wireless charging. The apparatus for charging area detection includes a plurality of first induction coils fixedly disposed in a preset manner and a positioning auxiliary circuit connected to the plurality of first induction coils, wherein the positioning auxiliary circuit indicates a relative position of a center of a magnetic field according to induced voltages induced by the first induction coils. Therefore, the center of an alternating magnetic field can be determined more conveniently and quickly, thereby facilitating the improvement of the wireless charging efficiency and the use experience of a user.

### CLAIM OF PRIORITY AND CROSS-REFERENCE TO RELATED APPLICATION(S)

This application claims the benefit of Chinese Patent Application No. 202011187041.8, filed on Oct. 29, 2020, which is incorporated herein by reference in its entirety.

### BACKGROUND OF THE INVENTION

### 1. Field of the Invention

The present disclosure relates to the technical field of wireless charging, and particularly to an apparatus for charging area detection.

### 2. Description of the Related Art

With the development of the wireless charging technology, various wireless power transmitters emerge on the market. When in use, a wireless power transmitter, as shown in FIG. 1, can be mounted under a table top; and an electronic device to be charged such as a mobile phone is placed on the table top. When a power transmitting coil built in the electronic device to be charged is in a range of an alternating magnetic field generated by the wireless power transmitter, a voltage is induced for charging. Due to the influence of the thickness of the table top and the performances of the wireless power transmitter itself, only when the electronic device to be charged is located above the center of the alternating magnetic field, the coupling performance of the magnetic field is good, and the charging efficiency is high. If the electronic device to be charged deviates from the above of the center of the alternating magnetic field, then the coupling performance of the magnetic field is poor, and the charging efficiency is low.

Generally, the center of the wireless power transmitting coil in the wireless power transmitter can be treated as the center of the alternating magnetic field. However, when the table top is made from a non-transparent material, it is not easy to determine the center of the alternating magnetic field. Furthermore, when the position of the electronic device to be charged deviates from the center of the magnetic field, the charging efficiency will be low, or the device will be damaged due to serious heating of the device.

### BRIEF DESCRIPTION OF THE INVENTION

According to one aspect of the present disclosure, the present disclosure provides an apparatus for charging area detection used for positioning a center of an alternating magnetic field generated by a wireless power transmitter, and the apparatus comprises a plurality of first induction coils and a positioning auxiliary circuit; wherein the plurality of first induction coils is fixedly disposed in a preset manner; the positioning auxiliary circuit is electrically connected to the plurality of first induction coils, and used for indicating a relative position of the center of the magnetic field according to induced voltages induced by the first induction coils.

In accordance with the abovementioned apparatus for charging area detection, the positioning auxiliary circuit is connected to the plurality of first induction coils which are fixedly disposed in a preset manner, and indicates the relative position of the center of the alternating magnetic field generated by the wireless power transmitter according to induced voltages induced by the first induction coils. Therefore, the center of the alternating magnetic field can be determined more conveniently and quickly, thereby facilitating the improvement of the wireless charging efficiency and the use experience of the user.

### BRIEF DESCRIPTION OF THE DRAWINGS

Through the following description of the embodiments of the present disclosure with reference to the drawings, the above and other objectives, features and advantages of the present disclosure will become more apparent, wherein:

FIG. 1 is a schematic view of a wireless power transmitter in the prior art;

FIG. 2 is a schematic view of an apparatus for charging area detection according to one embodiment of the present disclosure;

FIG. 3 is a sectional view of the apparatus for charging area detection according to one embodiment of the present disclosure;

FIG. 4 is a first schematic view of the position distribution of first induction coils according to one embodiment of the present disclosure;

FIG. 5 is a second schematic view of the position distribution of the first induction coils according to one embodiment of the present disclosure;

FIG. 6 is a third schematic view of the position distribution of the first induction coils according to one embodiment of the present disclosure;

FIG. 7A-FIG. 7C are schematic views how the apparatus for charging area detection moves during determination of a center of a magnetic field according to some embodiment of the present disclosure;

FIG. 8 is a schematic view of another position distribution of the first induction coils according to one embodiment of the present disclosure;

FIG. 9A-FIG. 9B are other schematic views how the apparatus for charging area detection moves during determination of the center of the magnetic field according to some embodiment of the present disclosure;

FIG. 10 is another schematic view of the apparatus for charging area detection according to one embodiment of the present disclosure;

FIG. 11 is a schematic view of a positioning auxiliary circuit according to one embodiment of the present disclosure;

FIG. 12 is a schematic view of a first position relationship between the first induction coils and a second induction coil according to one embodiment of the present disclosure;

FIG. 13 is a schematic view of a second position relationship between the first induction coils and the second induction coil according to one embodiment of the present disclosure;

FIG. 14 is a schematic view of a third position relationship between the first induction coils and the second induction coil according to one embodiment of the present disclosure; and

FIG. 15A-FIG. 15C are schematic views how the apparatus for charging area detection moves during determination of the center of the magnetic field according to some embodiment of the present disclosure.

### DETAILED DESCRIPTION OF EMBODIMENTS OF THE INVENTION

Several preferred embodiments of the present disclosure will be described in detail in conjunction with the accompanying drawings as follows, however, the present disclosure is intended to encompass any substitutions, modifications, equivalents, etc., made thereto without departing from the spirit and scope of the present disclosure. In order to provide those skilled in the art with thorough understanding of the present disclosure, particular details will be described below in the preferred embodiments of the present disclosure, although those skilled in the art can understand the present disclosure without the description of these details.

In addition, a person skilled in the art should understand that the drawings herein are provided for the purpose of description only, and are not necessarily drawn in proportion.

Furthermore, it should be understood that in the following descriptions, “circuit” refers to an electrical circuit formed by electrically connecting or electromagnetically connecting at least one element or sub-circuit. When one element or circuit is “connected to” another element or one element/circuit is “connected” between two nodes, the one element/circuit can be directly coupled or connected to another element or via an intermediate element, and the connection between the elements can be a physical connection, a logical connection or a combination thereof. On the contrary, when one element is “directly coupled to” or “directly connected to” another element, it means that no intermediate element is provided between the two elements.

Unless otherwise stated, the terms “comprise”, “include” and the like in the specification shall be interpreted as inclusive rather than exclusive or exhaustive; in other words, the terms mean “include but not limited to”.

In the descriptions of the present disclosure, it should be understood that the terms like “first”, “second” and the like are used for the purpose of description only, but cannot be considered to indicate or imply relative importance. In addition, in the descriptions of the present disclosure, unless otherwise stated, the meaning of “a plurality of” is two or more.

FIG. 1 is a schematic view of a wireless power transmitter in the prior art. As shown in FIG. 1, an electronic device to be charged 100 is placed on a table top 200. A wireless power transmitter 300 is mounted under the table top 200, and is used to generate an alternating magnetic field to charge the electronic device to be charged 100.

It should be understood that the electronic device to be charged 100 in the embodiment of the present disclosure may be a smart phone, a tablet computer, a smart watch, a wireless headphone, or other electronic devices capable of realizing wireless charging in a range of the alternating magnetic field generated by the wireless power transmitter 300. The wireless power transmitter 300 of the present embodiment includes an inverter circuit for outputting an alternating current, and a resonance circuit connected to the inverter circuit. When in use, the resonance circuit receives the alternating current outputted by the inverter circuit, and converts the alternating current into an alternating magnetic field, such that the electronic device to be charged in the alternating magnetic field can induce a corresponding voltage and realize wireless charging.

When the electronic device to be charged 100 is located above the center of the alternating magnetic field, the coupling performance of the magnetic field is good, and the charging efficiency is high. If the electronic device to be charged 100 deviates from the above of the center of the alternating magnetic field, the coupling performance of the magnetic field is poor, and the charging efficiency is low; furthermore, the device may be damaged due to serious heating in the device. On such basis, the apparatus for charging area detection provided by the embodiment of the present disclosure is used to quickly position the center of the alternating magnetic field generated by the wireless power transmitter.

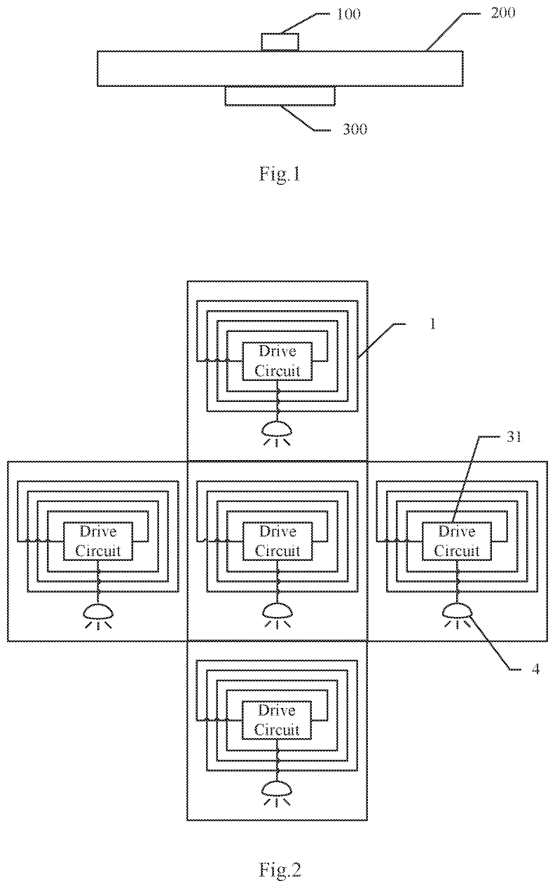

FIG. 2 is a schematic view of an apparatus for charging area detection according to one embodiment of the present disclosure. As shown in FIG. 2, the apparatus for charging area detection of the embodiment of the present disclosure includes a plurality of first induction coils 1 and a positioning auxiliary circuit, wherein the plurality of first induction coils 1 are fixedly disposed in a preset manner; and the positioning auxiliary circuit is electrically connected to the plurality of first induction coils 1, and is used to indicate a relative position of the center of the alternating magnetic field generated by the wireless power transmitter according to induced voltages induced by the first induction coils 1. Therefore, the positioning auxiliary circuit can indicate the relative position of the center of the magnetic field according to the induced voltages induced by the first induction coils 1, thereby facilitating the quick positioning of the center of the alternating magnetic field.

A person skilled in the art could easily understand that after the center of the alternating magnetic field generated by the wireless power transmitter is determined, the position of the center of the magnetic field can be intuitively displayed through marking. When a user performs wireless charging, the electronic device to be charged is directly placed in the center of the magnetic field, thereby facilitating the improvement of the wireless charging efficiency of the wireless power transmitter and the improvement of the use experiment of the user.

Optionally, the positioning auxiliary circuit of the present embodiment may include a plurality of positioning auxiliary sub-circuits. The positioning auxiliary circuit includes a plurality of positioning auxiliary sub-circuits in one-to-one correspondence with the first induction coils. Therefore, the plurality of positioning auxiliary sub-circuits respectively acquire corresponding induced voltage values of the corresponding first induction coils, and indicate the relative position of the center of the alternating magnetic field according to the plurality of induced voltage values, thereby improving the accuracy of positioning the center of the magnetic field, and further improving the wireless charging efficiency of the wireless power transmitter and the use experience of the user.

Further, in order to more intuitively compare the induced voltage values on different first induction coils, as shown in FIG. 2, the positioning auxiliary sub-circuits of the present embodiment include at least one indicator light 4 and a drive circuit 31, wherein the drive circuit 31 is electronically connected to the indicator light 4 and the corresponding first induction coils 1, and supplies power to the corresponding indicator light 4 through the induced voltages on the first induction coils 1. Therefore, the corresponding induced voltages on the first induction coils 1 at different positions can be intuitively reflected on the basis of the luminance of the indicator light 4, and the relative position of the center of the magnetic field can be indicated according to the distribution of the induced voltages on the plurality of first induction coils 1, thereby improving the efficiency of determining the center of the magnetic field, and facilitating the propulsion of a wireless charging process.

Optionally, any of the first induction coils of the present embodiment may adopt a printed circuit board, a flexible circuit board, or a coil formed by winding a conducting wire or a litz wire, which may facilitate the design and manufacturing of the first induction coils, and may further facilitate the manufacturing and use of the apparatus for charging area detection.

Furthermore, the indicator light of the present embodiment may be an LED lamp. The luminous intensity of the LED lamp is directly related to the voltage at the two ends thereof; the stronger the coupling between the first induction coils and the alternating magnetic field is, the greater the corresponding induced voltage is, the greater the corresponding output power of the drive circuit 31 is, and the greater the luminance of the indicator light is. On such basis, the induced voltage values on the corresponding first induction coils can be determined on the basis of the luminance change of the LED lamp; the method is simpler and more intuitive, and can more conveniently determine the center of the magnetic field according to the induced voltage values on the first induction coils.

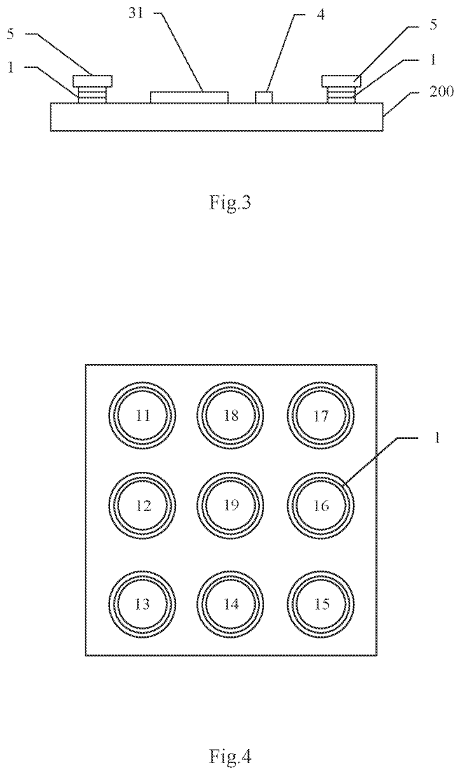

FIG. 3 is a sectional view of the apparatus for charging area detection according to one embodiment of the present disclosure. As shown in FIG. 3, the apparatus for charging area detection of the present embodiment further includes at least one magnetic sheet 5, wherein the magnetic sheet 5 is disposed on the first induction coils 1. The magnetic sheet 5 improves the coupling performance between the first induction coils 1 and the alternating magnetic field generated by the wireless power transmitter, thereby facilitating the determination of the center of the magnetic field according to the induced voltages on the first induction coils 1.

FIG. 4-6 are schematic views of the position distribution of the first induction coils according to some embodiments of the present disclosure. As shown in FIG. 4 -6, in some optional embodiments, the plurality of first induction coils 1 of the present embodiment are disposed in a centrosymmetric or axisymmetric manner. Optionally, the number of first induction coils may be three or more, and the first induction coils may include one central first induction coil and a plurality of peripheral first induction coils, wherein the central first induction coil is arranged at the center of the plurality of first induction coils, while the peripheral first induction coils are uniformly distributed on the periphery of the central first induction coil.

As shown in FIG. 4, in one optional embodiment, the number of the first induction coils is set as nine, including induction coils 11-19 which are respectively connected to an indicator light, wherein the induction coil 19 is located in the center of the plurality of induction coils, and the induction coils 11-18 are uniformly distributed on the periphery of the induction coil 19 to form a square arrangement structure.

As shown in FIG. 5, in one optional embodiment, the number of the first induction coils is set as nine, including induction coils 11-19 which are respectively connected to an indicator light, wherein the induction coil 19 is located in the center of the plurality of induction coils, and the induction coils 11-18 are uniformly distributed on the periphery of the induction coil 19 to form an annular arrangement structure.

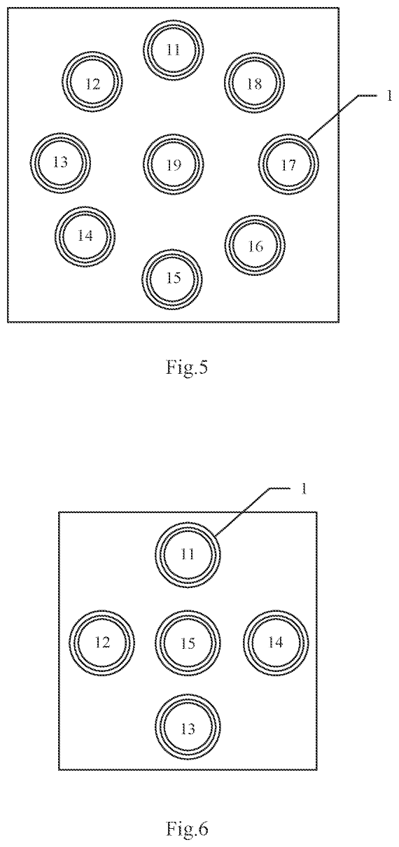

As shown in FIG. 6, in one optional embodiment, the number of the first induction coils is set as five, including an induction coil 11, an induction coil 12, an induction coil 13, an induction coil 14, and an induction coil 15 which are respectively connected to an indicator light, wherein the induction coil 15 is located in the center of the plurality of first induction coils, and the induction coil 11, the induction coil 12, the induction coil 13, and the induction coil 14 are uniformly distributed on the periphery of the induction coil 15 to form, together with the induction coil 15, a “cruciform” arrangement structure.

In the present embodiment, the process of determining the center of the alternating magnetic field is described by taking five first induction coils as an example. When the plurality of first induction coils are placed in the alternating magnetic field generated by the wireless power transmitter, the first induction coils can generate the induced voltages; and the voltage value when the indicator light is brightened is matched with the intensity of the alternating magnetic field generated by the wireless power transmitter.

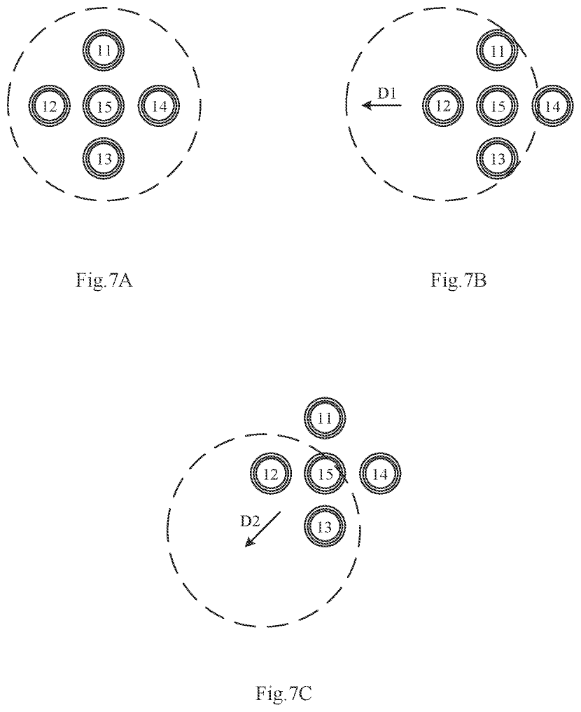

FIG. 7A-FIG. 7C are schematic views how the apparatus for charging area detection moves during determination of a center of a magnetic field according to one embodiment of the present disclosure. As shown in FIG. 7A-FIG. 7C, the dotted line part is used to denote the range of the alternating magnetic field generated by the wireless power transmitter.

As shown in FIG. 7A, when the apparatus for charging area detection is located in the alternating magnetic field, the induction coil 11, the induction coil 12, the induction coil 13, the induction coil 14, and the induction coil 15 all can induce the induced voltages. Furthermore, when the induction coil 15 is located in the center of the alternating magnetic field, the corresponding induced voltage can brighten all the indicator lights corresponding to the induction coil 11, the induction coil 12, the induction coil 13, the induction coil 14 and the induction coil 15, wherein the indicator light corresponding to the induction coil 15 is brightest.

When determining the center of the alternating magnetic field, take a case shown in FIG.7B as an example, the indicator lights corresponding to the induction coil 11, the induction coil 12, the induction coil 13 and the induction coil 15 are brightened; the indicator light corresponding to the induction coil 12 is brightest; and the indicator light corresponding to the induction coil 14 is not brightened. Therefore, it can be determined that the induction coil 12 is closest to the center of the magnetic field according to the luminance situations of the indicator lights. The apparatus for charging area detection may be moved in a direction D1 as shown by the arrow in FIG. 7B until it reaches a position as shown in FIG. 7A; the indicator lights corresponding to all the first induction coils are brightened, wherein the indicator light corresponding to the induction coil 15 is brightest; and the position corresponding to the induction coil 15 is the center of the alternating magnetic field.

In another case, when the apparatus for charging area detection is located at a position as shown in FIG. 7C, the indicator lights corresponding to the induction coil 12, the induction coil 13, and the induction coil 15 are brightened, and the indicator lights corresponding to the induction coil 11 and the induction coil 14 are not brightened, which means the positions corresponding to the induction coil 12 and the induction coil 13 are closer to the center of the magnetic field. Therefore, the apparatus for charging area detection may be moved in a direction D2 as shown by the arrow in FIG. 7C until it reaches the position as shown in FIG. 7A; the indicator lights corresponding to all the first induction coils are brightened, wherein the indicator light corresponding to the induction coil 15 is brightest; and the position corresponding to the induction coil 15 is the center of the alternating magnetic field.

It should be noted that the structure of the first induction coils in the figures of the present embodiment is only for exemplary purpose, and the winding wire of each first induction coil is consecutive in practical use.

It should be understood that the number of the first induction coils can be adjusted according to practical use situations. Furthermore, the first induction coils on a first periphery of the central position form a square or annular shape. Therefore, a plurality of arrangement modes could be provided, such that the user can perform arrangement according to a use requirement thereof, thereby improving the adaptability of the apparatus for charging area detection, and extending the application range of the apparatus for charging area detection.

If the user has a high requirement for positioning precision, then the number of the first induction coils may increase according to practical requirements. Furthermore, the peripheral first induction coils may be arranged in one circle, and may also be arranged in multiple circles, to improve the positioning precision of the center of the magnetic field. If the user has a strict requirement for cost, then the number of the first induction coils may decrease according to practical requirements, or the first induction coil arranged in the center may be saved, thereby reducing the steps, time and manpower for designing the apparatus for charging area detection, and reducing the economic cost, time cost and manpower cost for positioning the center of the magnetic field.

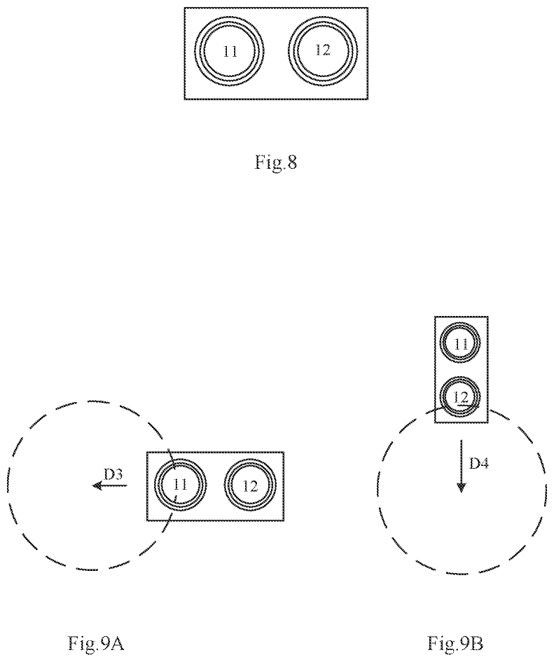

FIG. 8 is a schematic view of another position distribution of the first induction coils according to one embodiment of the present disclosure. In the embodiment as shown in FIG. 8, the apparatus for charging area detection includes two first induction coils, wherein the two first induction coils are fixedly disposed in a preset manner. Optionally, the two first induction coils are disposed in the same plane.

In the present disclosure, FIG. 9A and FIG. 9B are other schematic views how the apparatus for charging area detection moves during determination of the center of the magnetic field according to one embodiment of the present disclosure. As shown in FIG. 9A and FIG. 9B, the first induction coils of the present embodiment include an induction coil 11 and an induction coil 12.

When the center of the alternating magnetic field is determined, first the apparatus for charging area detection moves in a horizontal direction (the direction D3 as shown in FIG. 9A); then, a central position range in the horizontal direction could be determined according to the luminance of the indicator lights corresponding to the induction coil 11 and the induction coil 12. Afterwards, the apparatus for charging area detection rotates by 90 degrees, and then moves in a vertical direction (the direction D4 as shown in FIG. 9B perpendicular to the direction D3 as shown in FIG. 9A; then, a central position range in the vertical direction could be determined according to the luminance of the indicator lights corresponding to the induction coil 11 and the induction coil 12. Finally, an overlapped position of the two central position ranges is treated as the center of the alternating magnetic field generated by the wireless power transmitter. Therefore, two induction coils are provided to position the center of the magnetic field, thereby further reducing the manufacturing cost of the apparatus for charging area detection.

In the technical solution of the present embodiment, the induced voltages are acquired on the basis of the luminance of the indicator lights corresponding to the plurality of first induction coils; and the center of the alternating magnetic field generated by the wireless power transmitter is indicated on the basis of the plurality of acquired induced voltages. Therefore, the center of the alternating magnetic field can be determined more conveniently and quickly, thereby facilitating the improvement of the wireless charging efficiency and the use experience of the user.

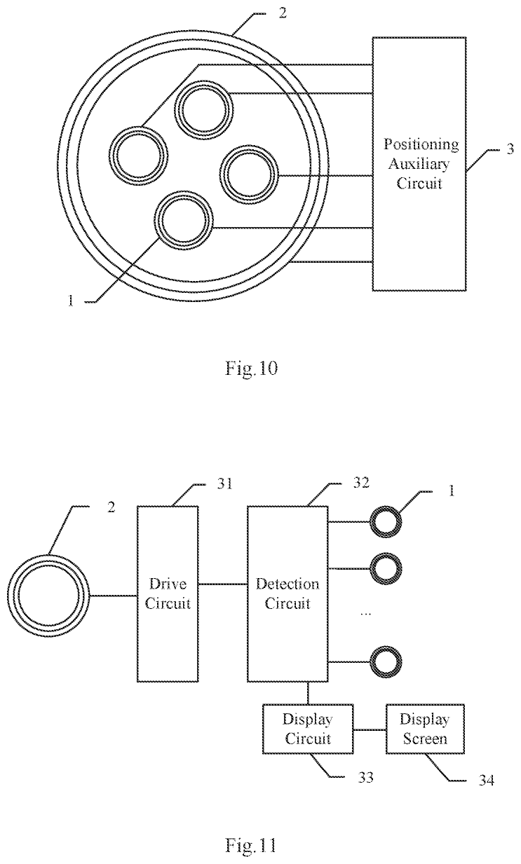

FIG. 10 is another schematic view of the apparatus for charging area detection according to one embodiment of the present disclosure. As shown in FIG. 10, the apparatus for charging area detection of the present embodiment includes first induction coils 1, a second induction coil 2, and a positioning auxiliary circuit 3, wherein the plurality of first induction coils 1 are fixedly disposed in a preset manner, and can induce with the second induction coil 2 to generate an induced voltage; and the positioning auxiliary circuit 3 is electrically connected to the second induction coil 2 and the plurality of first induction coils 1, and is used to indicate a relative position of the center of the alternating magnetic field generated by the wireless power transmitter according to induced voltages induced by the first induction coils 1, thereby facilitating the quicker positioning of the center of the alternating magnetic field, and facilitating the improvement of the wireless charging efficiency and the use experience of a user.

Optionally, the plurality of first induction coils may be disposed in an axisymmetric or centrosymmetric manner relative to the second induction coil, thereby facilitating the arrangement of the first induction coils and the second induction coil.

Further, the second induction coil of the present embodiment may have a size greater than the size of the first induction coils, thereby improving the coupling performance of the second induction coil and the alternating magnetic field, and facilitating the supply of the induced voltage to the first induction coils.

FIG. 11 is a schematic view of a positioning auxiliary circuit according to one embodiment of the present disclosure. As shown in FIG. 11, the positioning auxiliary circuit 3 of the present embodiment includes a detection circuit 32 and a drive circuit 31. wherein the detection circuit 32 is electrically connected to the plurality of first induction coils 1, and is used to respectively detect the induced voltages on the plurality of first induction coils 1; and the drive circuit 31 is electrically connected to the second induction coil 2, and is used to supply power to the detection circuit 32. Therefore, the detection circuit 32 detects the induced voltages on the plurality of first induction coils 1, and indicates the center of the magnetic field according to the detected multiple induced voltages.

Optionally, as shown in FIG. 11, the positioning auxiliary circuit 3 of the present embodiment further includes a display circuit 33 and a display screen 34, wherein the display circuit 33 is electrically connected to the detection circuit 32, is used to display the induced voltages on the plurality of first induction coils 1 detected by the detection circuit 32, and performs digital display through the display screen 34. Therefore, the display screen 34 intuitively displays the corresponding induced voltages on the plurality of first induction coils 1, and indicates the center of the alternating magnetic field on the basis of the induced voltages corresponding to the plurality of first induction coils 1.

Further, the detection circuit 32 in the present embodiment may also adopt a voltage detection chip. Therefore, the voltage detection chip detects the induced voltages on the first induction coils 1, such that the corresponding induced voltages on the plurality of first induction coils 1 could be quickly detected, thereby facilitating the improvement of detection precision and the accuracy of positioning the center of the magnetic field.

Optionally, the first induction coils and the second induction coil of the present embodiment may adopt a printed circuit board, a flexible circuit board, or a coil formed by winding a conducting wire or a litz wire, thereby facilitating the design and manufacturing of the first induction coils, and further facilitating the manufacturing and use of the apparatus for charging area detection.

Optionally, the apparatus for charging area detection of the present embodiment further includes a magnetic sheet (unshown in the figure), wherein the magnetic sheet is disposed on the first induction coils. The magnetic sheet improves the coupling performance between the first induction coils and the alternating magnetic field generated by the wireless power transmitter, thereby facilitating the determination of the center of the magnetic field according to the induced voltages on the first induction coils.

FIG. 12-FIG. 14 are schematic views of position relationships between the first induction coils and the second induction coil according to some embodiments of the present disclosure. As shown in FIG. 12-FIG. 14, the first induction coils of the present embodiment are disposed in a centrosymmetric manner; and the first induction coils are disposed below the second induction coil.

As shown in FIG. 12, in one optional embodiment, the first induction coils of the present embodiment are totally four, including an induction coil 11, an induction coil 12, an induction coil 13, and an induction coil 14, wherein the plurality of induction coils are uniformly distributed in a region on an inner side below the second induction coil 2, and form a square arrangement structure.

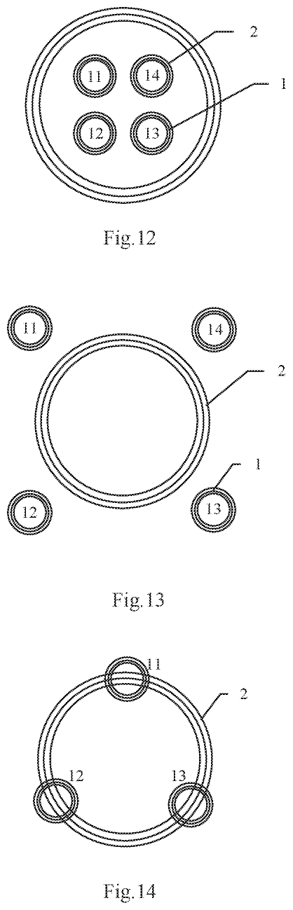

As shown in FIG. 13, in one optional embodiment, the first induction coils of the present embodiment are totally four, including an induction coil 11, an induction coil 12, an induction coil 13, and an induction coil 14, wherein the plurality of induction coils are uniformly distributed in a region on an outer side below the second induction coil 2, and form a square arrangement structure.

As shown in FIG. 14, in one optional embodiment, the first induction coils of the present embodiment are totally three, including an induction coil 11, an induction coil 12, and an induction coil 13, wherein the induction coil 11, an induction coil 12, and an induction coil 13 are uniformly distributed below the second induction coil 2 at a position opposite to an outer edge of the second induction coil 2.

It should be understood that the plurality of first induction coils of the present embodiment may be disposed on an inner side, at an edge, or on an outer side below the second induction coil 2 according to practical use requirements. Therefore, the positions of the first induction coils and the second induction coil could be more flexible and convenient, thereby facilitating the improvement of the adaptability of the apparatus for charging area detection.

Furthermore, the number of the first induction coils of the present embodiment can be set according to practical use requirements. Therefore, owing to different quantities of the first induction coils having different position relationships, the apparatus for charging area detection can be arranged in various modes, such that the user can perform arrangement according to a use requirement thereof, thereby improving the adaptability of the apparatus for charging area detection, and extending the application range of the apparatus for charging area detection.

The present embodiment describes the process of determining the center of the magnetic field by taking the following configurations as an example: the number of the first induction coils is three; the three first induction coils are uniformly distributed below the second induction coil at the position opposite to an outer edge of the second induction coil; and the corresponding induced voltages on the plurality of first induction coils are acquired through the voltage detection chip.

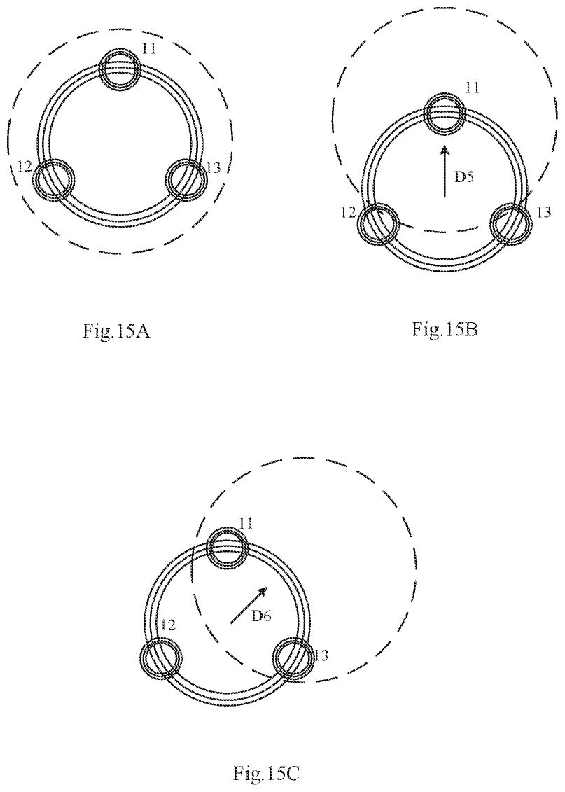

FIG. 15A-FIG. 15C are schematic views how the apparatus for charging area detection moves during determination of the center of the magnetic field according to one embodiment of the present disclosure. As shown in FIG. 15A-FIG. 15C, the dotted line part is used to denote the range of the alternating magnetic field generated by the wireless power transmitter.

When the center of the magnetic field is determined, as shown in FIG. 15A, when the apparatus for charging area detection is located in the alternating magnetic field, the induction coil 11, the induction coil 12 and the induction coil 13 all can induce the induced voltages. When the induced voltages detected by the voltage detection chips corresponding to the induction coil 11, the induction coil 12 and the induction coil 13 all reach a preset value (which can be a maximum value or a maximum value in an allowable error range), the center of the shape structure formed by the induction coils 11-13 is the center of the alternating magnetic field.

As shown in FIG. 15B, when the induced voltage detected by the voltage detection chip corresponding to the induction coil 11 is greater than the induced voltages detected by the voltage detection chips corresponding to the induction coil 12 and the induction coil 13, it indicates that the position corresponding to the induction coil 11 in the alternating magnetic field is close to the center of the magnetic field. The apparatus for charging area detection may be moved in a direction D5 as shown by the arrow in FIG. 15B until to a specified position; and the induced voltages detected by the voltage detection chips corresponding to the induction coil 11, the induction coil 12 and the induction coil 13 all reach the preset value. Therefore, the center of the shape structure formed by the induction coils 11-13 is determined as the center of the alternating magnetic field.

As shown in FIG. 15C, when the induced voltages corresponding to the induction coil 11 and the induction coil 13 are close and the induced voltage corresponding to the induction coil 12 is less than the induced voltages corresponding to the induction coil 11 and the induction coil 13, it indicates the positions corresponding to the induction coil 11 and the induction coil 13 are close to the center of the magnetic field. The apparatus for charging area detection may be moved in a direction D6 as shown by the arrow in the FIG. 15C until to a specified position; and the induced voltages detected by the voltage detection chips corresponding to the induction coil 11, the induction coil 12 and the induction coil 13 all reach the preset value. Therefore, the center of the shape structure formed by the induction coils 11-13 is determined as the center of the alternating magnetic field.

In the technical solution of the present embodiment, the induced voltages are detected by the corresponding voltage detection chips on the plurality of first induction coils; and the center of the alternating magnetic field generated by the wireless power transmitter can be indicated on the basis of the plurality of detected induced voltages. Therefore, the center of the magnetic field can be positioned more conveniently and quickly, thereby facilitating the improvement of the wireless charging efficiency and the use experience of the user.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is intended that the scope of the present disclosure be defined by the claims appended hereto and their equivalents.

I/we claim:

1. A apparatus for charging area detection, used for positioning a center of an alternating magnetic field generated by a wireless power transmitter, and comprising:
a plurality of first induction coils, fixedly disposed in a preset manner; and
a positioning auxiliary circuit, electrically connected to the plurality of first induction coils, and used for indicating a relative position of the center of the magnetic field according to induced voltages induced by the first induction coils.

2. The apparatus of claim 1, wherein the plurality of first induction coils are disposed in a centrosymmetric or axisymmetric manner.

3. The apparatus of claim 2, wherein the number of first induction coils is two, the two first induction coils are arranged in the same plane.

4. The apparatus of claim 1, wherein the positioning auxiliary circuit comprises:
a plurality of positioning auxiliary sub-circuits, corresponding to the first induction coils in one-to-one, and comprising:
at least one indicator light; and
a drive circuit, electrically connected to the indicator light and the corresponding first induction coil, and supplying power to the indicator light through the induced voltages on the first induction coils.

5. The apparatus of claim 1, further comprises:
a second induction coil, having a size greater than the size of the first induction coils and electrically connected to the positioning auxiliary circuit.

6. The apparatus of claim 5, wherein the plurality of first induction coils are disposed in an axisymmetric or centrosymmetric manner relative to the second induction coil.

7. The apparatus of claim 5, wherein the plurality of first induction coils are on an inner side, at an edge, or on an outer side of the second induction coil directly below.

8. The apparatus of claim 5, wherein the positioning auxiliary circuit comprises:
a detection circuit, electrically connected to the plurality of first induction coils, and used for respectively detecting the induced voltages on the plurality of first induction coils, and indicating the center of the magnetic field according to the induced voltages; and
a drive circuit, electrically connected to the second induction coil, and used for supplying power to the detection circuit.

9. The apparatus of claim 1, wherein the charging positioning apparatus further comprises:
at least one magnetic sheet, disposed on the first induction coils.

10. The apparatus of claim 1, wherein any of the first induction coils comprises a printed circuit board, a flexible circuit board, or a coil formed by winding a conducting wire or a litz wire.

11. The apparatus of claim 1, wherein the indicator light is a LED lamp.

12. The apparatus of claim 1, wherein the positioning auxiliary circuit further includes:
a display circuit, electrically connected to the detection circuit; and
a display screen, electrically connected to the display circuit;
wherein the display circuit is configured to display the induced voltages on the plurality of first induction coils detected by the detection circuit, and perform digital display through the display screen.

13. The apparatus of claim 1, wherein the first induction coils include:
a central first induction coil, arranged at the center of the plurality of first induction coils; and
a plurality of peripheral first induction coils, uniformly distributed on the periphery of the central first induction coil.

14. The apparatus of claim 13, wherein the peripheral first induction coils are arranged in one or more circle.
